(19) United States
(12) Patent Application Publication
(10) Pub. No.: US 2010/0252378 A1
(43) Pub. Date: Oct. 7, 2010

(54) Control Device for a Brake System of a Utility Vehicle and Method for Controlling a Brake System

(75) Inventor: Eduard HILBERER, Hockenheim (DE)

Correspondence Address: CROWELL & MORING LLP;INTELLECTUAL PROPERTY GROUP, P.O. BOX 14300, WASHINGTON, DC, 20044-4300, US

(73) Assignee: KNORR-BREMSE Systeme fuer Nutzfahrzeuge GmbH, Muenchen (DE)

(21) Appl. No.: 12/699,640

(22) Filed: Feb. 3, 2010

Related U.S. Application Data
(63) Continuation of application No. PCT/EP2008/006530, filed on Aug. 7, 2008.

(30) Foreign Application Priority Data
Aug. 8, 2007 (DE) 10 2007 037 346.7

(51) Int. Cl. B60T 13/68; B60T 8/176; B60T 8/86; B60T 7/12; G06F 19/00; B60T 8/88; B60T 17/04

(52) U.S. Cl. 188/106 F; 303/127; 303/113.1; 303/123; 701/70

(57) ABSTRACT

A control device and a method for a brake system of a utility vehicle are provided. The brake system includes service brake cylinders and spring brake cylinders for braking the utility vehicle, an electronic control device, sensors for detecting the state of motion of the utility vehicle, a foot brake valve for actuating the service brake, a manual control unit, a module encompassing electrically controllable valves for an anti-blocking system, and a module encompassing electrically controllable valves for an electrically controlled parking brake. The electronic control device influences both the anti-lock system and the electrically controlled parking brake.

### CROSS-REFERENCE TO RELATED APPLICATIONS

This application is a continuation of PCT International Application No. PCT/EP2008/006530, filed Aug. 7, 2008, which claims priority under 35 U.S.C. §119 from German Patent Application No. DE 10 2007 037 346.7, filed Aug. 8, 2008, the entire disclosures of which are herein expressly incorporated by reference.

### BACKGROUND AND SUMMARY OF THE INVENTION

The invention relates to a control device for a brake system of a utility or commercial vehicle, wherein the brake system includes service brake cylinders and spring brake cylinders for braking the utility vehicle, an electronic control device, sensors for sensing the state of movement of the utility vehicle, a foot brake valve for activating the service brake, a manual control unit by which driver requests which are dependent on the method of activation of the manual control unit can be transmitted to the electronic control device, a module having electrically actuable valves for an anti-lock brake system and a module having electrically actuable valves for an electrically controlled parking brake.

Furthermore, the invention relates to a method for controlling a brake system for a utility or commercial vehicle which can be coupled to a trailer, having service brake cylinders and spring brake cylinders for braking the utility vehicle, an electronic control device, sensors for sensing the state of movement of the utility vehicle, a foot brake valve for activating the service brake, a manual control unit by which driver requests which are dependent on the method of activation of the manual control unit are transmitted to the electronic control device, a module having electrically actuable valves for an anti-lock brake system and a module having electrically actuable valves for an electrically controlled parking brake having a pneumatic control connection which can be coupled to a control inlet of a trailer control module.

Brake systems for utility or commercial vehicles are generally subject to strict regulations concerning fail safety and operational safety. Particular emphasis is usually placed here on redundancy of the service brake circuits in order to be able to reliably bring the utility vehicle to a stop even in the event of a defect. Furthermore, the intention is to make available a parking brake which is as failsafe as possible, in order to reliably prevent the vehicle from unintentional rolling away. Further partially electronically controlled driving safety systems such as ABS, ESP, etc. have become conventional depending on the purpose of use of the utility vehicles. As a result it is possible, in particular in the case of lightweight, small utility vehicles, for there to be a situation in which it is necessary to install either highly integrated complete solutions, which exceed the desired safety features by far, or autonomous individual systems, which are specially adapted to the customer's requirements for the respective utility vehicles. An electronic brake system (EBS) constitutes such a highly integrated safety solution for a utility vehicle, which solution combines known driving safety systems such as ABS, ESP, etc. Continuous, pressure-load-dependent closed-loop control of the braking effect is performed for all the axes, in which case the closed-loop control circuit is closed both by way of pressure sensors and by use of wheel speed sensors. Furthermore, the trailer control, for example for anti-jackknifing braking, is carried out electrically.

It may be appropriate both to install a highly integrated driving safety system and to use autonomous systems, which possibly then do not have all the desired properties. Using a highly integrated driving safety system, which is usually installed only in large and heavy utility vehicles (such as Class 8 trucks) and can meet all customer's requirements, would generally not only increase the costs for the more lightweight utility vehicle but also the weight of the entire safety equipment can significantly increase the overall weight of the more lightweight utility vehicle and take up valuable installation space since it is also necessary to install components which are not required. The costs, the weight, and the installation space which is taken up, are less significant in the heavy utility vehicle since they make up only a fraction of the overall price, the overall weight, or the available space. In particular in the case of lightweight utility vehicles it may, on the other hand, be desirable to achieve savings in terms of weight and installation space by using autonomous systems.

EP 1 504 975 B1 describes a pressure-medium-operated brake system for a vehicle, wherein the transmission of signals for activating the parking brake is carried out electrically.

An object of the invention is to reduce the necessary components for integrating the driving safety systems which are desired in particular for a lightweight utility vehicle while increasing the fail safety. At the same time, the intention is to utilize as many as possible of the available synergies in terms of functionality, without adversely affecting the safety of the utility vehicle.

This and other objects are achieved according to the invention by providing a control device for a brake system of a utility vehicle, wherein the brake system comprises: service brake cylinders and spring brake cylinders for braking the utility vehicle, an electronic control device, sensors for sensing the state of movement of the utility vehicle, a foot brake valve for activating the service brake, a manual control unit by which driver requests which are dependent on the method of activation of the manual control unit can be transmitted to the electronic control device, and a module having electrically actuable valves for an anti-lock brake system and a module having electrically actuable valves for an electrically controlled parking brake. The electronic control device performs the influencing of both the anti-lock brake system and the electrically controlled parking brake. If the brake system of the lightweight utility vehicle has both an anti-lock brake system and an electrically controlled parking brake, a single electronic control unit can be used for both driving safety systems. The electronic control unit performs closed-loop control on the control system of the anti-lock brake system, and at the same time, controls the function of the electrically controlled parking brake. In this way, it is possible to dispense with an electronic control unit, which could otherwise constitute an additional source of faults. The driving safety system which is provided in this way can also be integrated into any desired utility vehicle independently of other components. In particular, the integration of an EBS is not a precondition. Furthermore, the ABS system can, in the case of brake boosting, now directly influence the parking brake by way of the common control device. This is advantageous since it then results in a time advantage over separate systems in which the ABS system can influence the parking brake only via a detour through the CAN bus.

There may advantageously be provision that the module having electrically actuable valves for the anti-lock brake system and the module having electrically actuable valves for the electrically controlled parking brake at least partially use common air pressure inlets and air pressure outlets. Combining previously separate inlets and outlets of the individual driving safety systems permits a saving in terms of pneumatic control lines, which are complex to mount and susceptible to faults.

Furthermore there may be provision that the module having electrically actuable valves for the anti-lock brake system at least partially prevents the spring brake cylinders from being ventilated if the parking brake is ventilated, wherein maximum pressure loading of the cylinder is taken into account. This measure prevents overloading of the wheel brake since otherwise as well as the spring force of the parking brake the ventilation by the service brake would also load the cylinders. Such a function can be implemented, for example, by use of an additional solenoid, referred to as a hold magnet, which is arranged in the ABS system.

It is advantageously possible to provide that the module having electrically actuable valves for the anti-lock brake system at least partially prevents the spring brake cylinders from being ventilated by the parking brake if the service brake is already activated, wherein maximum pressure loading of the cylinder is taken into account. This measure also avoids overloading of the cylinders, wherein the force acting on the cylinders is held at a constant high level.

In order to reliably shut down the utility vehicle it is possible to provide that the parking brake can also be ventilated when the service brake is being ventilated, wherein maximum pressure loading of the cylinder is taken into account. The cylinder side of the parking brake is slowly ventilated here, while the service brake remains ventilated but the associated cylinder side is slowly vented in synchronism with the ventilation of the parking brake side, in order to avoid overloading of the cylinder.

It is advantageously possible to provide that the parking brake can be vented when the service brake is simultaneously activated, wherein maximum pressure loading of the cylinder is taken into account. This situation is typical during starting off. The function prevents the utility vehicle from rolling away while the maximum permissible cylinder pressure is maintained, wherein the pressures prevailing in the cylinder components are determined by way of sensors. The brake can then be enabled after the engine drive torque has been increased to the level of the braking torque, wherein additional torque is also requested by the CAN bus in order to avoid rolling away. In this context, the wheel speed sensors of the ABS system and of the tachograph are also taken into account.

In addition, it is possible to provide that the control device actuates the module having electrically actuable valves for the electrically controlled parking brake, such that when the spring brake cylinder of the utility vehicle is ventilated, the control line to the trailer is vented in order to test whether the traction vehicle can hold the entire train.

Furthermore, it is possible to provide that the trailer brake can be released by way of the manual control unit. It is advantageously possible to provide that the control device can go into a standby state when a wakeup signal is received. In the standby state, the parking brake can be opened or closed. It is also possible to provide that the ABS system and the electrically controlled parking brake operate only when the ignition is switched on.

Alternatively it is possible to provide that the ABS system and the electrically controlled parking brake begin to operate after the ignition is switched on, and after the ignition is switched off an oscillator-controlled run-on time occurs until the control device is at least partially deactivated.

Advantageously, the module having electrically actuable valves for the anti-lock brake system and the module having electrically actuable valves for the electrically controlled parking brake are arranged on a housing which accommodates the common electronic control device. This arrangement minimizes electric control lines from the electronic control device to the electrically actuable valves, which are present in the two modules, and from the pressure sensors, which are present in the modules to the electronic control device. This further increases the fail safety of the driving safety systems since the number of components which are susceptible to faults is reduced again.

The function of the anti-lock brake system and the function of the electrically controlled parking brake can be deactivated separately from one another. If the anti-lock brake system or the electrically controlled parking brake has a defect, a residual function can be maintained through the possibility of the separate deactivation of the faulty subsystem. As a result, the safety of the utility vehicle is improved.

A pneumatic control connection, which can be coupled to a control inlet of a trailer control module, is provided on the module for the electrically controlled parking brake, and the electronic control device can make available via the pneumatic control connection an anti-jackknifing braking function for the trailer if such anti-jackknifing braking is requested. The anti-jackknifing braking function prevents the trailer from reaching a higher speed than the utility vehicle since such a situation could ultimately lead to jackknifing of a vehicle train (tractor-trailer combination) composed of a utility vehicle and a trailer and therefore to a very unsafe driving situation. The utility vehicle can in this way be equipped with a further driving safety feature without additional complex assemblies having to be integrated. The trailer should advantageously be equipped here with wheel speed sensors and be connected to the CAN bus. The wheel speed information of the trailer is then transmitted to the control device and used to perform closed-loop control of the anti-jackknifing braking. The trailer is then not controlled electrically, as in the case of an EBS, but rather pneumatically.

A redundant voltage supply is provided for the electronic control device. The redundant voltage supply of the control device increases the fail safety of the driving safety systems since, in the event of a failure of one of the two voltage supplies of the electronic control device, the functionality of the driving safety systems is maintained.

It is advantageously possible to provide the electronic control device with a connection to a serial bus system. Modern utility vehicles usually have a large number of subsystems. These subsystems are usually connected to a serial bus system, such as the CAN bus, which is present in the utility vehicle, in order to exchange data with one another. For example, a trailer which is connected to the utility vehicle and to the CAN bus could have wheel speed sensors whose information, which relates to the wheel speed of the individual wheels of the trailer, could be transmitted via the CAN bus to the control device and could be used to perform closed-loop control of anti-jackknifing braking. Furthermore, it is contemplated that the load state of the utility vehicle is sensed and taken into account in the closed-loop control of the ABS.

Furthermore there may be provision for the vehicle acceleration measured values to be transmitted to the control device via the connection to the serial bus system.

The sensors of the brake system for sensing the state of movement of the utility vehicle include yaw sensors and the service brake cylinder pressure is subjected to closed-loop control as a function of the acceleration of the utility vehicle about the transverse axis and longitudinal axis. Modern ABS systems can also include additional vehicle-stabilizing functions such as roll-over prevention (RSP), that is to say a function for preventing the vehicle from rolling over, or an ESP function, that is to say a vehicle movement dynamics control system for avoiding skidding of the vehicle. In these functions, the brake cylinder pressure is also determined as a function of the measured accelerations of the vehicle about the transverse axis and the vertical axis. The measurement of the acceleration of the vehicle is carried out by the yaw rate sensors and the measured values are also fed to the control device. Yaw sensors sense the rotation of the utility vehicle about the utility vehicle axes. The rotation of the utility vehicle about the vertical axis is essential information for reducing the risk of the vehicle rolling over (RSP). The additional functions can be considered to be an extension of the conventional ABS functionality. Furthermore, in such a function the deviation of the average speed of the vehicle from the speed determined by the wheel speed sensors is taken into account.

There may advantageously be provision that the service brake cylinder pressure is subjected to closed-loop control as a function of at least one of the following variables:

parking brake cylinder pressure,

parking brake value signal generator pressure,

fault state of the system,

status of the foot brake value signal generator, and

speed of utility vehicle and wheel size.

Taking into account the system variables specified above provides further advantages in the implementation of the system according to the invention and permits more efficient closed-loop control of the system. For example, double pressure loading of the parking brake cylinders by the service brake can be avoided if a pressure, which is already applied, is taken into account together with the wheel size influences, for example, the speed of the utility vehicle which is determined by the rotational speed sensors, wherein the speed of the utility vehicle also determines the risk of rolling over for example.

Furthermore, the parking brake cylinder pressure is subjected to closed-loop control as a function of the handbrake value signal generator. This closed-loop control provides advantages, for example within the scope of an incremental parking brake.

The brake system makes the traction control system function available, wherein the electronic control device performs the closed-loop control of the traction control system. A traction control system is ultimately closely related to an anti-lock brake system and can therefore be integrated without further components into the control device and the modules which are arranged thereon and have electronically actuable valves.

According to a method for controlling a brake system according to the invention, the electronic control device initiates controlled anti-jackknifing braking using the module for the electrically controlled parking brake and, in particular, the control connection which is present, and monitors to determine if anti-jackknifing braking is requested. In this way, the advantages and particular features of the brake system according to the invention are also implemented within the scope of the method.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a simplified block circuit diagram of a control device according to an exemplary embodiment of the invention and of the connected modules having electrically actuable valves, wherein possible electrical and pneumatic connections are illustrated;

FIG. 2 shows a more detailed block circuit diagram of the control device and of the connected modules having electrically actuable valves, illustrating the possible use of common compressed air outlets;

FIG. 3 shows a possible embodiment of a module for controlling the parking brake, which is at the same time capable of making available an anti-jackknifing braking function;

FIG. 4 is a circuit diagram of part of a brake system according to exemplary embodiments of the invention, illustrating the possible embodiments for the control device and the modules having electrically actuable valves;

FIG. 5 is a circuit diagram of part of a brake system according to exemplary embodiments of the invention, illustrating the possible embodiments for the control device and the modules having electrically actuable valves; and

FIG. 6 is a schematic illustration of the utility vehicle, illustrating the possible positioning of individual components of the brake system.

### DETAILED DESCRIPTION OF THE DRAWINGS

In the subsequent description of the drawings, identical reference signs denote identical or comparable components.

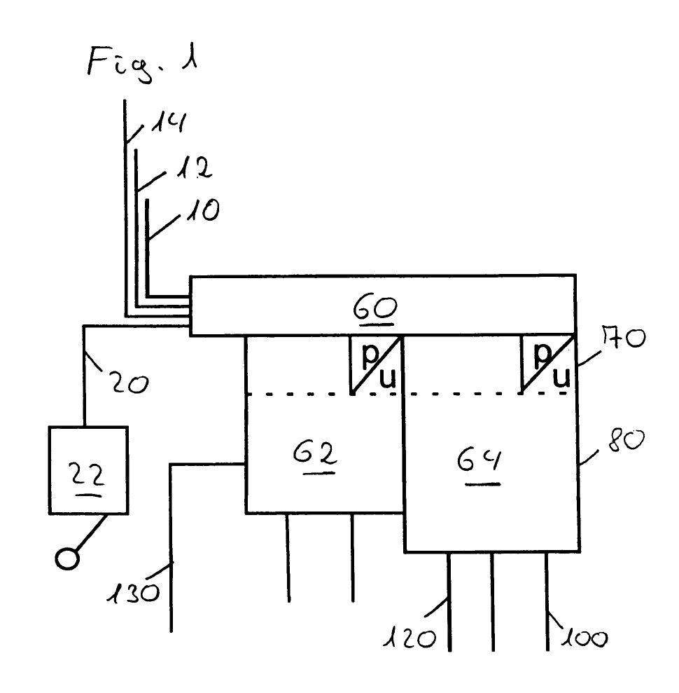

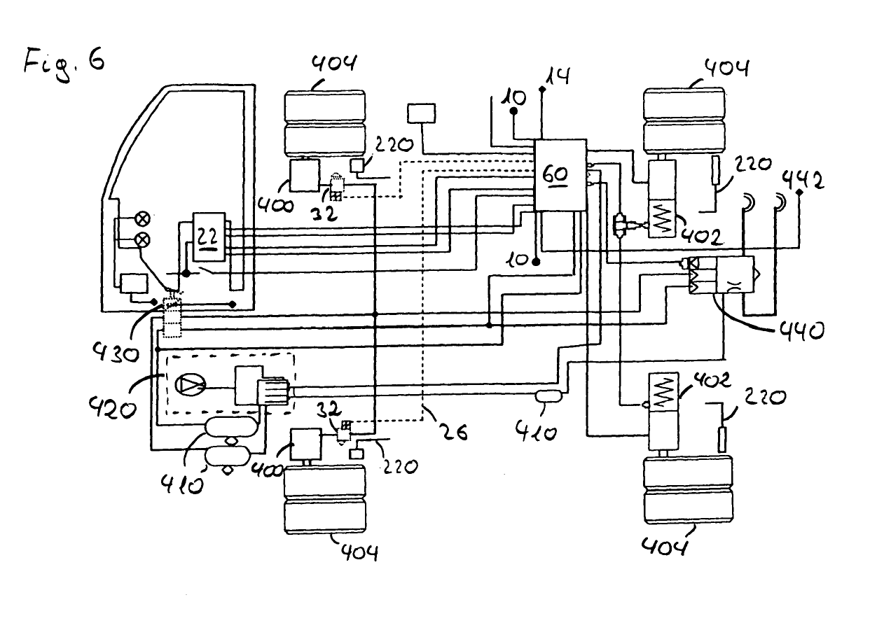

FIG. 1 is a simplified block circuit diagram of a control device 60 and of the connected modules 62, 64 having electrically actuable valves, wherein possible electrical and pneumatic connections are illustrated. Furthermore, a manual control unit 22 is illustrated by which a driver request can be transmitted to the control device 60. By way of the manual control unit 22, the driver can trigger a test function (described in more detail later) for the brake system and the actuation and release of the electrically controlled parking brake. The connections illustrated in FIG. 1 include an electrical connection 10, which ensures a redundant voltage supply for the control device 60, an electrical connection 14 for coupling the control device 60 to the CAN bus of the utility vehicle, a connection 20 which connects the control device 60 to the manual control unit 22, a pneumatic connection 100 for coupling to at least one spring brake cylinder 402, see for example FIG. 6, of the parking brake, a pneumatic connection 120 for coupling to a control inlet of a trailer control module, and a pneumatic connection 130 for coupling to at least one service brake cylinder 400, see for example FIG. 6, of the utility vehicle. In particular, the spatial arrangement of the control device 60 and of the modules 62, 64 with electrically actuable valves can be seen. The necessary pressure sensors and solenoid valves are preferably arranged in the upper region 70 (separated off by dashed lines) of the modules 62, 64 having electrically actuable valves, in order to keep the connecting lines to the control device 60 as short as possible. In the lower region 80 of the modules 62, 64 having electrically actuable valves, the further necessary components are arranged such as, for example, piping, nonreturn valves etc. In addition to the illustrated connections of the control device 60 and of the modules 62, 64 having electrically actuable valves, further connections for further extension of the anti-lock brake system are contemplated. Furthermore, the modules 62, 64 also include compressed air supply connections (not illustrated).

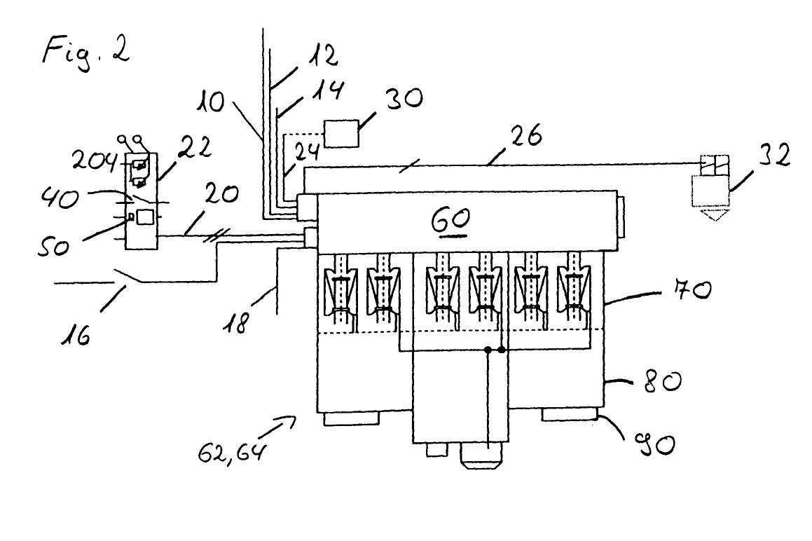

FIG. 2 shows a more detailed block circuit diagram of the control device 60 and the modules 62, 64 which are arranged thereon and have electrically actuable valves in order to illustrate the possible use of common compressed air outlets. In particular it is illustrated how the piping in the lower region 80 of the modules 62, 64 having electrically actuable valves can be configured so that the modules 62, 64 of the anti-lock brake system and of the electrically controlled parking brake use common compressed air connections. The control device 60 again has a redundantly configured voltage connection 10, a connection 14 to the CAN bus, a connection 20 to the manual control unit 22, a connection 16 for the anti-jackknifing braking value signal generator, wherein the latter can also be integrated into the manual control unit 22. Furthermore, connections 26 for ABS modulators 32, connections 24 for ESP sensors 30 and connections 18 for wheel speed sensors are present, wherein the wheel speed sensors are arranged, in particular, on the wheels on which ABS modulators are present. Solenoid valves, whose outputs are combined by way of example in the lower region 80 of the modules 62, 64, are arranged in the upper region 70, separated off by dashed lines, of the modules 62, 64. It is possible to combine the connections to the reservoir vessel, the control connections for service brake cylinders or spring brake cylinders and the discharge connections of the modules 62, 64 in the illustrated manner. The combined connections can be led out of the lower regions 80 of the modules 62, 64 via a common connection plate 90.

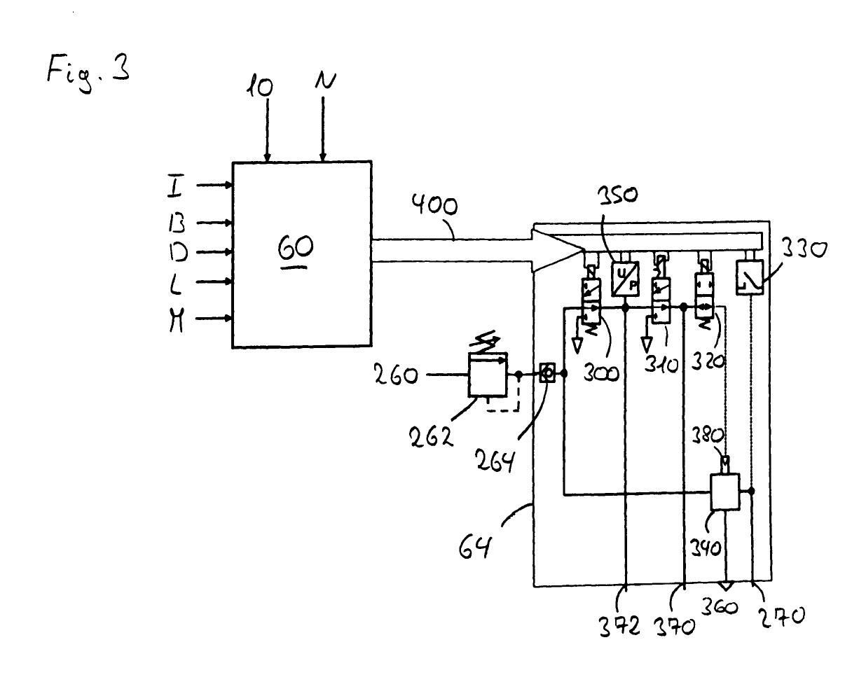

FIG. 3 shows a possible embodiment of a module 64 for controlling the parking brake, which is simultaneously capable of making available an anti-jackknifing braking function. The module 64 having electrically actuable valves for controlling the electric parking brake includes a compressed air supply line 260 which supplies the module 64 with compressed air via a pressure limiter 262 with a nonreturn valve 264 connected downstream. The module also contains a valve device 300 which can be controlled in a pulse-width-modulated fashion and has both a connection 270 for a spring brake cylinder and two control connections 370, 372 which can be coupled to a control inlet of a trailer control module. The module 64 is preferably suitable for making available the function of an electrically controlled parking brake system. For this purpose, the module contains the essential valve device 300 which is configured as a 3/2 way valve and a 2/2 way valve 320. The control inlet 380 of a relay valve 340 is actuated as a function of the switched position of the above-mentioned valve devices 300, 320. The relay valve 340 is supplied with pressure from the supply line 260 which is passed on to the spring brake cylinder connection 270 as a function of the control pressure present at the control inlet 380 of the relay valve 340. Furthermore, a pressure switch 330 is provided by which it is possible to sense whether the spring brake cylinder connection 270 is ventilated or vented, that is to say whether the parking brake is engaged or released. In the illustrated position of the 2/2 way valve 320, the spring brake cylinder connection 270 can be ventilated or vented as a function of the position of the 3/2 way valve 300. If the 2/2 way valve 320 is switched over, the pressure at the spring brake cylinder connection 270 is maintained.

As a result of the interplay of the 3/2 way valve 300 with the 2/2 way valve 320, it is also possible to implement a test function for the utility vehicle by virtue of the fact that, specifically when the spring brake cylinder connection 270 is vented, the control inlet of the trailer control module which is connected to the control connection 370 is briefly ventilated via the control connection 370. The ventilation of this control inlet results in venting of the trailer brake system, with the result that the entire vehicle train has to be kept in this state by the utility vehicle, wherein the vented state of the spring brake connection 270 can be maintained by switching over the 2/2 way valve 320 in its pressure-holding position.

A further important task is performed by the 3/2 way valve 300 in respect of an anti-jackknifing braking function. Since the 3/2 way valve 300 is actuated in a pulse-width-modulated fashion by the electronic control device 60, selective pressure can be made available for the trailer control module at the control connection 370. In particular, the trailer can be braked independently of the braking of the utility vehicle, with the result that it is possible to prevent the trailer from colliding with the rear of the utility vehicle. Whether such anti-jackknifing braking is permitted depends on the driving state of the vehicle. Since the driving state is taken into account by the data which are received via the CAN bus and are acquired by the wheel speed sensors 220, safety-critical aspects, for example steering maneuvers, can be taken into account, and it can be ensured that pulse-width modulation of the 3/2 way valve 300 takes place only if the anti-jackknifing braking functionality is actually required, which greatly increases the service life of the 3/2 way valve 300. The checking as to whether the pulse-width modulation of the 3/2 way valve 300 is basically permitted is made dependent, inter alia, on the signals B, D, I, L, M and N. These signals characterize the following driving states of the vehicle or are derived from said driving states, for example through comparison with threshold valves:

B: Status of engine electronics,

D: Retarder status,

I: Speed less than threshold value,

L: Steering angle or differential wheel speed,

M: Status of accelerator pedal and engine brake, and

N: Measured speed of the ABS.

The information about the driving states can be obtained from a wide variety of sources. The speed of the vehicle can be obtained, for example, from the speedometer of the vehicle. Likewise, the wheel speed sensors of the anti-lock brake system can be used since the signals thereof are more precise at low speeds than that of the speedometer. In addition, speed values of the navigation system can be included in the calculations as absolute values. The torque of the engine is available, for example, within the scope of the engine control. Wheel speed sensors are present for the steering angle and the differential wheel speed, respectively. Basically, the signals can be obtained directly or via a data bus. With respect to the sensing of the inclination of the vehicle it is in particular also necessary to note that the latter can be sensed by means of a sensor system; however, the navigation information can also be made available by the navigation system.

The discussed signals, and under certain circumstances further signals or variables derived therefrom, are input into the control device 60. The electronic control device 60 then brings about the pulse-width-width-modulated actuation 400 of the 3/2 way valve 300 as a function of the received signals, wherein pulse-width-modulated actuation 400 can be prevented, in particular, if it is clear, on the basis of one or more of the information items fed to the control device 60, that anti-jackknifing braking should not take place. The module 64 contains a further electrically actuable 3/2 way valve 310 which is equipped as a bistable valve. This solenoid valve 310 supplies the control connection 370 of the module 64 with compressed air with the result that the illustrated electropneumatic module 64 can make available a control pressure for the trailer control module either on the basis of a monostable valve design, specifically by means of the 3/2 way valve 300, or a bistable valve design, specifically by means of the 3/2-way valve 310. The electropneumatic module 64 can therefore cope with various requirement profiles of the utility vehicle manufacturers.

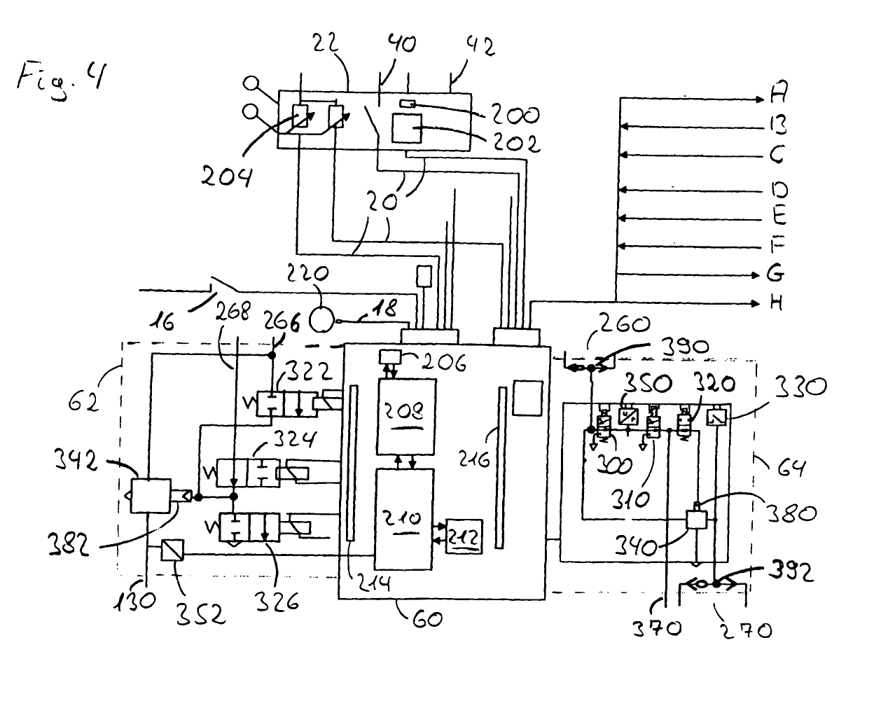

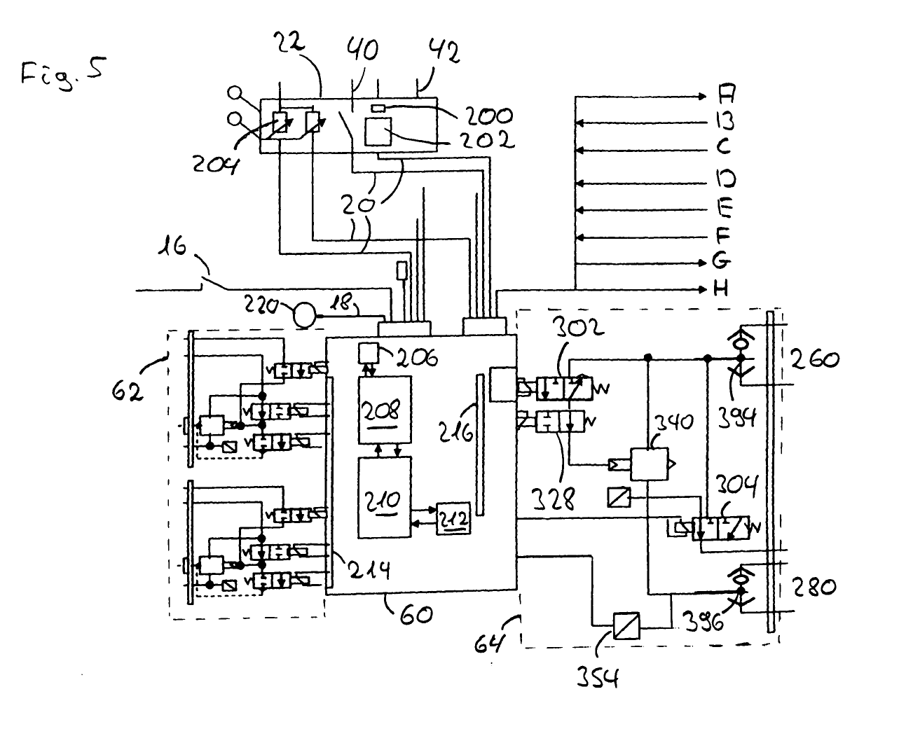

FIGS. 4 and 5 show switching diagrams of part of a brake system in order to illustrate possible embodiments for the control device 60 and the modules 62, 64 having electrically actuable valves. The switching diagrams show the control device 60, the microcontroller 208 and 210, two separate relays 214 and 216 for separate deactivation of the anti-lock brake system and of the electrically controlled parking brake, and a watchdog timer 212. A watchdog function is advantageous since in the context of the present invention it is a safety-relevant control function in which a microcontroller and a computer system have to be failsafe and have to at least partially switch off in the event of a fault. For this purpose, the watchdog timer 212 is provided in the control device 60. Furthermore, control devices with safety-relevant functions are advantageously redundantly supplied with power and have a write/read memory 206 in order to store the permissible open-loop and closed-loop control parameters and predefined threshold values, for example a speed threshold value, and fault states. Furthermore, possible connections of the control device 60 are illustrated. A connection 18 to a rotational speed sensor 220, a connection 16 to an anti-jackknifing braking value signal generator, a connection 34 to a yaw sensor 230, and a plurality of connections 20 to a manual control unit 22, which comprises a charging circuit 200, an accumulator 202, a wakeup switch 40, a ground line 42 and sensors 204, are shown. The connecting line 14 which connects to the CAN bus is also shown, and associated therewith the signals, characterized by A to H, which are input or output via this data line. In particular these are:

A: Status of the manual control unit,

B: Status of the engine electronics,

C: Status of clutch,

D: Status of retarder,

E: Status of transmission,

F: Wheel speed of trailer,

G: Status of ECPB, and

H: Status of ABS

However, further connections to the control device 60 can be provided according to requirements.

The valve devices 62 and 64 are connected to the control device 60. In FIG. 4, the module 64 for the electrically controlled parking brake is identical to the embodiment described in detail in FIG. 3. All that has been dispensed with is the control connection 372 which can, however, be re-inserted if necessary, and the compressed air supply 260 and the spring brake cylinder connection 270 with a pipe brake-protection device in the form of a redundant configuration with a shuttle valve 392 have been provided. In the event of a drop in pressure in one of the connecting lines, the illustrated shuttle valves 390, 392 always shut off the connecting line at which the relatively low pressure is present.

In FIG. 5, a further possible embodiment of a module 64 having electrically actuable valves of an electrically controlled parking brake, which makes available essentially the same functions, is illustrated. The pressure is supplied redundantly via the compressed air connection 260 and a shuttle valve 394. A relay valve 340 is actuated by a 2/2 way valve 328 and a 3/2 way valve 302 in order to implement an electric parking brake. Furthermore, a pressure sensor 354 is provided, which measures the pressure upstream of the shuttle valve 396. However, the pressure sensor can also be connected to the spring-loaded cylinder of the parking brake.

The modules 62 which are shown in FIGS. 4 and 5 for the anti-lock brake system differ in the number of identical assemblies illustrated. Additional identical assemblies may be necessary, for example, if additional axles of the utility vehicle are to be subjected to closed-loop control by the anti-lock brake system. If further axles or service brake cylinders are to be equipped with an anti-lock brake functionality, the module 62 must be expanded by a corresponding number of additional assemblies. The anti-lock brake system can be equipped, together with the control device 60, with a number of further functions:

Electronic braking force distribution (EBD),

Storage of the ABS events,

Brake diagnostics (BD),

Display of spinning rear axle wheels,

RSP for providing stabilization against rolling over, and

ESP for providing stabilization against rolling over and for providing yaw moment stabilization

Since the basic method of functioning and the design of an anti-lock brake system are generally known and are not essential for the invention, it is possible to dispense with a detailed explanation of the design and of the method of functioning of the module 62. Furthermore, the illustrated embodiment of the module 62 is to be considered only as one of the possible conventional embodiments of an anti-lock brake system. The individual module which is illustrated in FIG. 4 includes a relay valve 342 with a control inlet 382, a pressure sensor 352 and a plurality of 2/2 way valves 322, 324 and 326. A compressed air connection 266 is used in order to actuate the control inlet 382 of the relay valve 342 under the control of the 2/2 way valve 322. The relay valve 342 is supplied at pressure from the compressed air connection 266 and can operate a service brake cylinder by the pneumatic connection 130. The pressure which is present at the control inlet 382 can be reduced by way of the discharge valve 326. If the electronic control of the ABS fails, the 2/2 way valves 322, 324, 326, which are illustrated in FIG. 4, are switched automatically into the illustrated state. In this state, direct actuation of the relay valve via the 2/2 way valve 324 to provide pneumatic protection is possible. The pressure supply can be provided via a separate compressed air connection 268.

In addition to waking up the system by way of the wakeup switch, it is also contemplated to take into account signals via the CAN bus. For example, the system could be changed from an inactive state into an active state by switching on the ignition or by means of a general “wakeup” signal.

FIG. 6 shows a simplified system illustration of the utility vehicle illustrating the possible arrangement of individual components of the brake system. A foot brake valve 430 and the manual control unit 22 are arranged in the driver's cab. A driver's request, which is detected by the manual control unit 22 and/or the foot brake valve 430, is transmitted by electrical control lines to the connected control device 60 and converted there into a signal for the connected brake system. The brake system comprises service brake cylinders 400, spring brake cylinders 402, compressed air reservoirs 410 and a compressed air supply system 420 and can bring about deceleration of the utility vehicle in a known fashion by supplying the brake cylinders with compressed air. Furthermore, wheel speed sensors 220 and ABS modulators 32 are provided with separate sound absorbers for the venting process, in order to implement an anti-lock brake system for the utility vehicle. If the rear axle is also to be integrated into the anti-lock brake system, ABS modulators 32 with their own sound absorbers for venting must also be provided in the corresponding connecting lines between the control device 60 and the spring brake cylinders 402. The combination of individual components, such as the sound absorbers on an axle basis is possible.

A connection 442 for the trailer to the CAN bus and a trailer control module 440 are also illustrated even though the latter could easily be integrated into the trailer itself. The brake system is capable of carrying out anti-jackknifing braking of the vehicle train via the connection between the control device 60 and the trailer control module 440 if such braking is requested by the driver.

Table of Reference Numerals

| | |
|---|---|
| 10 | Connection of voltage supply (redundant) |
| 12 | Connection of service brake value signal generator |
| 14 | CAN connection |
| 16 | Connection of anti-jackknifing braking value signal |
| | generator |
| 18 | Connection of wheel speed sensors |
| 20 | Connection of manual control unit |
| 22 | Manual control unit |
| 30 | ESP sensors |
| 32 | ABS modulators |
| 34 | Connection of yawing sensor |
| 40 | Wakeup switch |
| 42 | Ground line (GND) |
| 50 | Accumulator circuit |
| 60 | Control device |
| 62 | Module having electrically actuable valves |
| 64 | Module having electrically actuable valves |
| 70 | Region |
| 80 | Region |
| 90 | Common control level |
| 100 | Pneumatic connection |
| 120 | Pneumatic connection |
| 130 | Pneumatic connection |
| 200 | Charging circuit |
| 202 | Accumulator |
| 204 | Sensors |
| 206 | Memory |
| 208 | Microcontroller |
| 210 | Microcontroller |
| 212 | Watchdog timer |
| 214 | Shutdown relay |
| 216 | Shutdown relay |
| 220 | Wheel speed sensor |
| 230 | Yaw sensor |
| 260 | Compressed air connection |
| 262 | Overpressure valve |
| 264 | Nonreturn valve |
| 266 | Compressed air connection |
| 268 | Compressed air connection |
| 270 | Spring brake cylinder connection |
| 280 | Parking brake cylinder connection |
| 300 | 3/2 way valve |
| 302 | 3/2 way valve |
| 304 | 3/2 way valve |
| 310 | Bistable 3/2 way valve |
| 320 | 2/2 way valve |
| 322 | 2/2 way valve |
| 324 | 2/2 way valve |
| 326 | 2/2 way valve |
| 328 | 2/2 way valve |
| 330 | Pressure switch |
| 340 | Relay valve |
| 342 | Relay valve |
| 350 | Pressure sensor |
| 352 | Pressure sensor |
| 354 | Pressure sensor |
| 360 | Venting means |
| 370 | Control connection |
| 372 | Control connection |
| 380 | Control inlet |
| 382 | Control inlet |
| 390 | Shuttle valve |
| 392 | Shuttle valve |
| 394 | Shuttle valve |
| 396 | Shuttle valve |
| 400 | Service brake cylinder |
| 402 | Spring brake cylinder |
| 404 | Wheel |
| 410 | Supply reservoir |
| 420 | Compressed air-supply system |
| 430 | Foot brake valve |
| 440 | Trailer control module |
| 442 | Trailer connection for CAN bus |

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A brake system for a utility vehicle, comprising:
service brake cylinders and spring brake cylinders operatively configured for braking the utility vehicle;
an electronic control device;
sensors for sensing a state of movement of the utility vehicle;
a foot brake valve for activating a service brake of the utility vehicle;
a manual control unit operatively configured to transmit to the electronic control device driver requests which are dependent on a method of activating the manual control unit;
a first module having electrically actuable valves for an anti-lock brake system;
a second module having electrically actuable valves for an electrically controlled parking brake; and
wherein the electronic control device is operatively configured to influence control of both the anti-lock brake system and the electrically controlled parking brake.

2. The system as claimed in claim 1, wherein the first module having electrically actuable valves for the anti-lock brake system and the second module having electrically actuable valves for the electrically controlled parking brake at least partially use common air pressure inlets and air pressure outlets.

3. The system as claimed in claim 2, wherein the first module having electrically actuable valves for the anti-lock brake system at least partially prevents the spring brake cylinders from being ventilated by the service brake if the parking brake is ventilated, wherein maximum pressure loading of the cylinder is taken into account.

4. The system as claimed in claim 2, wherein the first module having electrically actuable valves for the anti-lock brake system at least partially prevents the spring brake cylinders from being ventilated by the parking brake if the service brake is already activated, wherein maximum pressure loading of the cylinder is taken into account.

5. The system as claimed in claim 3, wherein the parking brake is also ventilatable when the service brake is being ventilated, wherein maximum pressure loading of the cylinder is taken into account.

6. The system as claimed in claim 3, wherein the parking brake is ventable when the service brake is simultaneously activated, wherein maximum pressure loading of the cylinder is taken into account.

7. The system as claimed in claim 1, wherein the electronic control device actuates the first module having electrically actuable valves for the electrically controlled parking brake such that when the spring brake cylinder of the utility vehicle is ventilated, the control line to a trailer is vented in order to test whether the utility vehicle can hold the entire train.

8. The system as claimed in claim 1, wherein a trailer brake is releasable by the manual control unit.

9. The system as claimed in claim 1, wherein the electronic control device can go into a standby state when a wakeup signal is received.

10. The system as claimed in claim 1, wherein the ABS system and the electrically controlled parking brake operate only when an ignition of the utility vehicle is switched on.

11. The system as claimed in claim 1, wherein the ABS system and the electrically controlled parking brake begin to operate after the ignition is switched on, and after the ignition is switched off, an oscillator-controlled run-on time occurs until the electronic control device is at least partially deactivated.

12. The system as claimed in claim 1, wherein a pressure sensor is configured to measure a pressure in parking brake cylinders connected to a connection, said pressure sensor being pneumatically connected to a parking brake relay outlet.

13. The system as claimed in claim 1, wherein a pressure sensor is connected by an electric line to the electronic control device and measures a pressure in parking brake cylinders which are connected to a connection, wherein said pressure sensor is arranged downstream of a shuttle valve.

14. The system as claimed in claim 1, wherein the first module having electrically actuable valves for the anti-lock brake system and the second module having electrically actuable valves for the electrically controlled parking brake are arranged on a housing which accommodates said electronic control device.

15. The system as claimed in claim 1, wherein a function of the anti-lock brake system and a function of the electric parking brake are deactivatable separately from one another.

16. The system as claimed in claim 1, wherein a pneumatic control connection, which is coupleable to a control inlet of a trailer control module, is provided on the second module for the electrically controlled parking brake; and
further wherein the electronic control device makes available via the pneumatic control connection an anti-jackknifing braking function for a trailer if such anti-jackknifing braking is requested.

17. The system as claimed in claim 1, wherein a redundant voltage supply is provided for the electronic control device.

18. The system as claimed in claim 1, wherein the electronic control device has a connection to a serial bus system.

19. The system as claimed in claim 18, wherein vehicle acceleration measured values are transmitted to the electronic control device via the connection to the serial bus system.

20. The system as claimed in claim 1, wherein the sensors of the brake system for sensing the state of movement of the utility vehicle comprise yaw sensors; and
further wherein that the service brake cylinders have a pressure subjected to closed-loop control as a function of the utility vehicle acceleration about its transverse axis and longitudinal axis.

21. The system as claimed in claim 20, wherein the service brake cylinder pressure is subjected to closed-loop control as a function of at least one of the following variables:
parking brake cylinder pressure,
parking brake value signal generator pressure,
fault state of the system,
status of the foot brake value signal generator, and
speed of utility vehicle and wheel size.

22. The system as claimed in claim 1, wherein the parking brake cylinder pressure is subjected to closed-loop control as a function of a handbrake value signal generator.

23. The system as claimed in claim 1, wherein the brake system makes available a traction control system function, wherein the electronic control device performs the closed-loop control of the traction control system.

24. A method for controlling a brake system for a utility vehicle coupleable to a trailer, the brake system comprising service brake cylinders and spring brake cylinders for braking the utility vehicle, an electronic control device, sensors for sensing a state of movement, a foot brake valve for activating the service brake, a manual control unit by which driver requests are transmitted to the electronic control device, and a first module having electrically actuable valves for an anti-lock brake system and a second module having electrically actuable valves for an electrically controlled parking brake having a trailer control valve for connecting the trailer, the method comprising the acts of:
monitoring the utility vehicle and trailer to determine if an anti-jackknifing braking is requested; and
initiating, by way of the electronic control device, controlled anti-jackknifing braking using the second module for the electrically controlled parking brake.

25. The method according to claim 24, wherein the act of using the second module for the electrically controlled parking brake uses a control connection present on the second module.
